(19) United States
(12) Patent Application Publication
(10) Pub. No.: US 2020/0002964 A1
(43) Pub. Date: Jan. 2, 2020

(54) SYSTEM AND METHOD FOR HYDRO-DEMOLITION OF CONCRETE STRUCTURES

(71) Applicant: Structural Group, Inc., Columbia, MD (US)

(72) Inventors: Barry Jackson, Kansas City, MO (US); Sam Dickson, Coraopolis, PA (US)

(21) Appl. No.: 16/459,836

(22) Filed: Jul. 2, 2019

Related U.S. Application Data
(60) Provisional application No. 62/693,099, filed on Jul. 2, 2018.

(51) Int. Cl. E04G 23/08; B26F 3/00

(52) U.S. Cl. CPC E04G 23/081; B26F 3/004

(57) ABSTRACT

Disclosed is a system and method for the demolition of vertical concrete structures. A moveable concrete cutting vehicle includes a carriage adapted to move along the top surface of the vertical concrete structure that is to be demolished. The carriage carries a cutting assembly that is moveable in at least two directions, such as a vertical direction and a slightly downwardly angled circumferential direction, which cutting assembly is positioned to make cuts through the entire width of the concrete wall of the vertical concrete structure. After a series of cuts have been performed, the carriage may be moved along the top, horizontal rim of the vertical concrete structure, and separable concrete blocks that have been formed in the previously processed region may be tipped off of the remaining vertical concrete structure to fall to the ground. Such process may continue with the carriage carrying the concrete cutting vehicle progressively downward and around the vertical concrete structure, allowing small, block-shaped sections of the concrete structure to be tipped into the concrete structure until the entire concrete structure has been demolished.

### CROSS REFERENCE TO RELATED APPLICATION

This application claims the benefit of U.S. Provisional Application No. 62/693,099 titled “System and Method for Hydro-Demolition of Concrete Structures,” filed Jul. 2, 2018 by the Applicant herein, which application is incorporated herein by reference in its entirety.

### FIELD OF THE INVENTION

This invention relates generally to systems and methods for demolition of concrete structures, and more particularly to systems and methods of vertically progressive hydro-demolition of vertical concrete structures.

### BACKGROUND

The demolition of vertical concrete structures, such as chimneys, silos, stacks, and the like, has been previously carried out in a variety of ways, and typically involve manual demolition, which given the extreme height of such structure, can entail significantly dangerous operations. Demolition methods have included controlled explosives (particularly where there is a wide, open area surrounding the structure into which the remnants may fall), boom crane demolition from the ground, and sawing and dropping pieces of the structure from the top of the structure. Construction of new and upgrading of old power generation facilities and the like are increasing the need for such demolition services. However, such previously known methods are expensive and lengthy to carry out, and often carry significant risk to the workers tasked with performing the demolition project.

Thus, there remains a need in the art for efficient methods and systems for the demolition of concrete structures, and particularly vertical concrete structures such as chimneys, silos, stacks, and the like, that avoid the disadvantages of previously known concrete demolition methods and systems.

### SUMMARY OF THE INVENTION

Disclosed herein is a system and method for the demolition of vertical concrete structures. A moveable concrete cutting vehicle includes a carriage that is adapted to ride or roll along the top-most surface of the vertical concrete structure that is to be demolished, such as the top, generally horizontal rim that extends around the perimeter of the vertical concrete structure. Such carriage in turn carries a cutting assembly that is moveable in at least two directions, such as a vertical direction and a slightly downwardly angled circumferential direction (e.g., varying between 2° and 8° depending upon the height of the cutting assembly), which cutting assembly is positioned to make cuts through the entire width of the concrete wall of the vertical concrete structure. After a series of cuts have been performed, the carriage may be moved along the top, horizontal rim of the vertical concrete structure, and separable concrete blocks that have been formed in the previously processed region may be tipped off of the remaining vertical concrete structure to fall to the ground. Such process may continue with the carriage carrying the concrete cutting vehicle progressively downward and around the vertical concrete structure, allowing small, block-shaped sections of the concrete structure to be tipped into the concrete structure until the entire concrete structure has been demolished.

In accordance with certain aspects of an embodiment, a moveable concrete cutting vehicle is provided, comprising: a moveable and steerable carriage adapted to ride along a top, horizontal wall adjacent an outer edge of a vertical concrete structure during demolition of the vertical concrete structure; and a cutting assembly carried by the moveable and steerable carriage, wherein the cutting assembly is moveable in at least two directions with respect to the carriage, and wherein the cutting assembly is positioned with respect to the carriage to make horizontal cuts through an outer wall of the concrete structure.

In accordance with further aspects of an embodiment, a method for demolishing a concrete structure is provided, comprising the steps of: providing a moveable concrete cutting vehicle comprising a moveable and steerable carriage adapted to ride along a top, horizontal wall adjacent an outer edge of a vertical concrete structure during demolition of the vertical concrete structure, and a cutting assembly carried by the moveable and steerable carriage, wherein the cutting assembly is moveable in at least two directions with respect to the carriage, and wherein the cutting assembly is positioned with respect to the carriage to make horizontal cuts through an outer wall of the concrete structure; positioning the moveable concrete cutting vehicle so that the carriage is positioned on a top surface of a wall of the concrete structure and the cutting assembly is positioned on an outside of the concrete structure; moving the cutting assembly to perform a plurality of vertical and downwardly angled circumferential cuts through the wall of the concrete structure below the carriage; moving the carriage along the top surface of the concrete structure; and tipping cut blocks of the wall of the concrete structure into an interior of the concrete structure to create a new top surface of the wall of the concrete structure.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a perspective view of a front side of a moveable concrete cutting vehicle for hydro-demolition of concrete structures in accordance with certain aspects of an embodiment of the invention.

FIG. 2 is a perspective view of the back side of the moveable concrete cutting vehicle of FIG. 1.

FIG. 3 is a top view of the moveable concrete cutting vehicle of FIG. 1 and FIG. 2.

FIG. 4 is a front view of the moveable concrete cutting vehicle of FIG. 1 and FIG. 2 from the perspective of line A-A of FIG. 3.

FIG. 5 is a cross-sectional view of the moveable concrete cutting vehicle of FIG. 1 and FIG. 2 along section line B-B of FIG. 3.

FIG. 6 is a schematic view of an exemplary cutting pattern for hydro-demolition of concrete structures using a moveable concrete cutting vehicle in accordance with further aspects of an embodiment of the invention.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

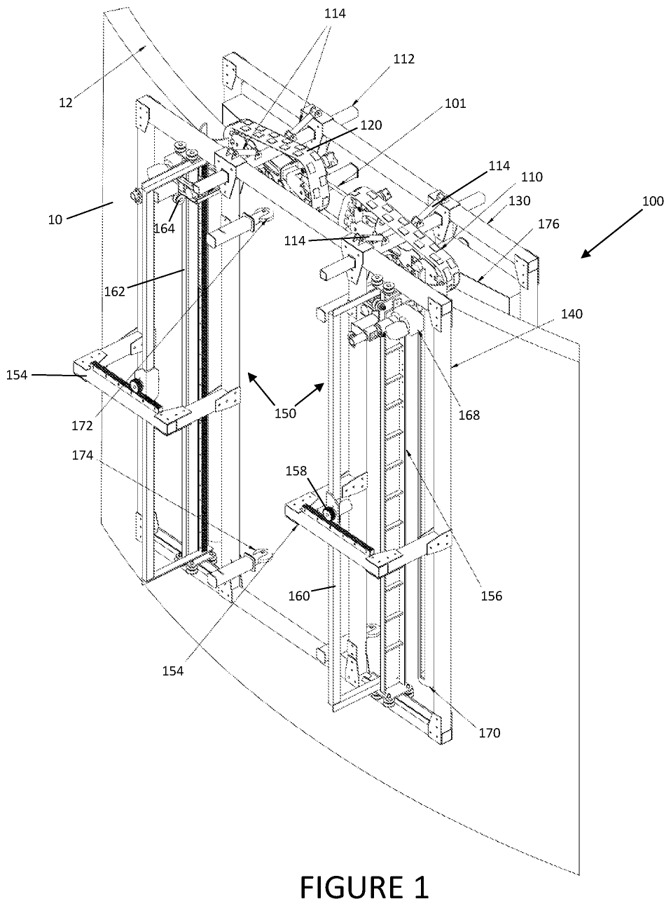

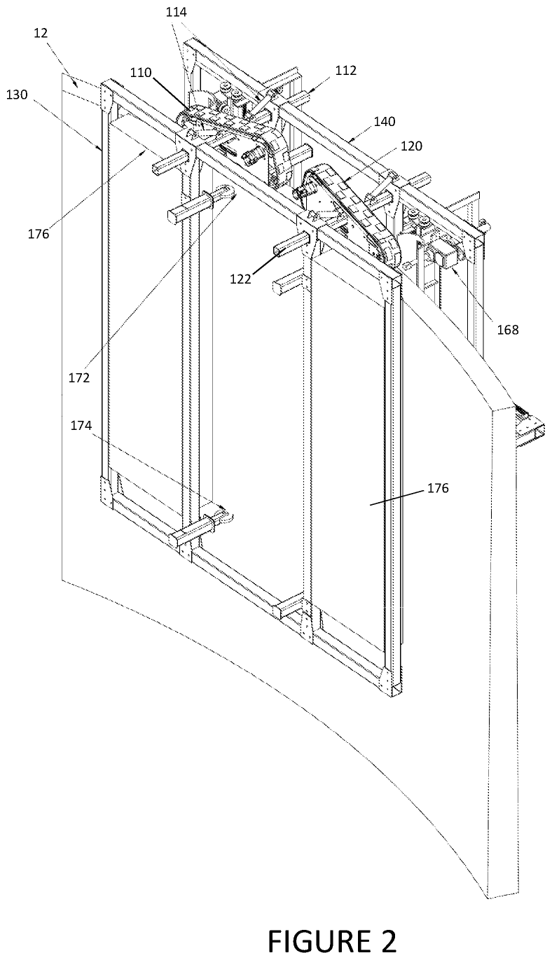

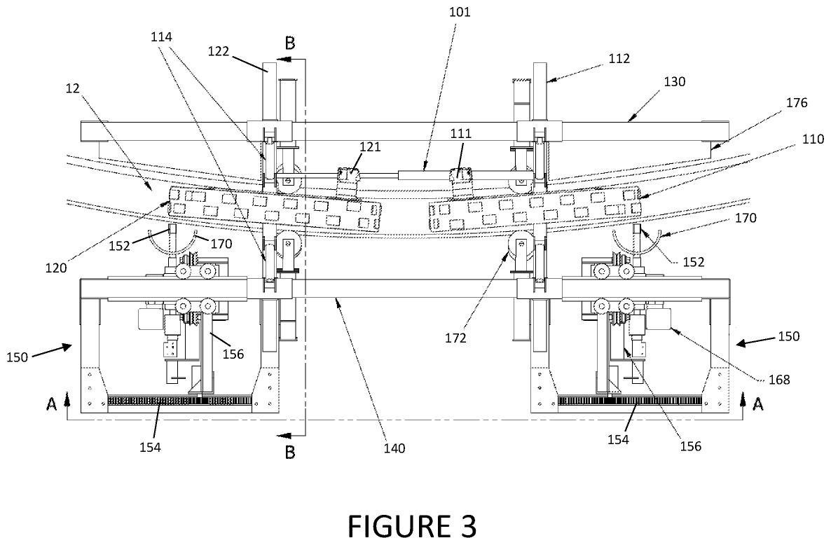

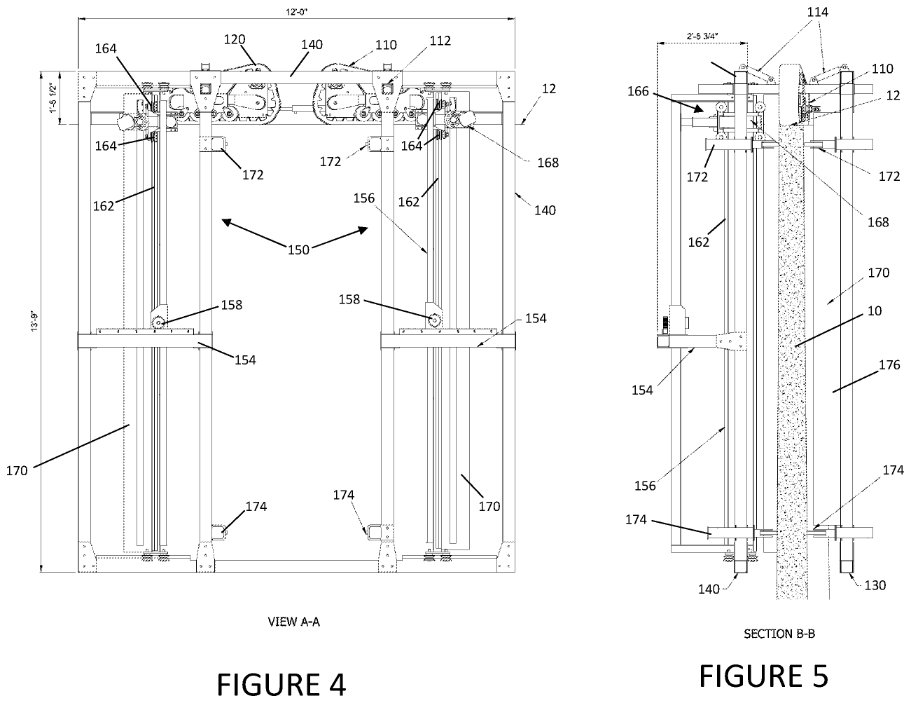

Disclosed herein is a method and system for the controlled, progressive hydro-demolition of vertical concrete structures, such as chimneys, silos, stacks, and the like. With reference to FIGS. 1-5, a moveable concrete cutting vehicle (shown generally at 100) is configured to ride along the top edge 12 of a concrete structure 10 to progressively cut sections of the wall of the concrete structure, moving from the top of the structure to the bottom of the structure, and using moveable high-pressure fluid (e.g., water) jets to cut through the concrete of the wall so as to enable cut sections to safely drop into the remaining structure with reduced risk to the workers, and with less debris thrown about from the demolition process. Moveable concrete cutting vehicle 10, and the concrete structure demolition method that it employs, improves upon previously known demolition methods and systems by providing a faster, less expensive, and more efficient means of demolition than previously known methods, and that likewise reduces safety and health risks to workers carrying out such process.

Generally, moveable concrete cutting vehicle 100 includes a carriage that is adapted to ride or roll along the top-most surface of the vertical concrete structure that is to be demolished, such as the top, generally horizontal rim that extends around the perimeter of the vertical concrete structure. Such carriage in turn carries a cutting assembly that is moveable in at least two directions, such as a vertical direction and a slightly downwardly angled circumferential direction (e.g., varying between 2° and 8° depending upon the height of the cutting assembly), which cutting assembly is positioned to make cuts through the entire width of the concrete wall of the vertical concrete structure. After a series of cuts have been performed, the carriage may be moved along the top, horizontal rim of the vertical concrete structure, and separable concrete blocks that have been formed in the previously processed region may be tipped off of the remaining vertical concrete structure to fall to the ground. Such process may continue with carriage carrying the concrete cutting vehicle 100 progressively downward and around the vertical concrete structure, allowing small, block-shaped sections of the concrete structure to be tipped into the concrete structure until the entire concrete structure has been demolished.

In accordance with a particularly preferred embodiment, such carriage of moveable concrete cutting vehicle 100 may include at least a first track 110, and more preferably both a first track 110 and a second track 120 which together carry inner frame 130 and outer frame 140. Each of first track 110 and second track 120 is preferably driven by a motor 111 and 121, respectively, to drive each track assembly. First track 110 preferably carries a first frame support beam 112, and second track 120 preferably carries a second frame support beam 122. Frame support beam 112 preferably attaches to frame support beam 122 via a hydraulic cylinder 101 that, through extension and contraction, may change the angle of each of first track 110 and second track 120 so as to allow moveable concrete cutting vehicle to be steered around the top wall 12 of concrete structure 10.

First frame support beam 112 and second frame support beam 122 may each extend through and support an upper member of inner frame 130 and outer frame 140, and thus carry frames 130 and 140 around concrete structure 10 as the demolition process proceeds. As concrete structures 10 may have varying wall thicknesses, hydraulic cylinders 114 may extend between a first mount on each of frame support beam 112 and frame support beam 122, and a second mount on the top of the upper members of inner frame 130 and outer frame 140, which hydraulic cylinders 114 may extend and contract to adjust for such varying wall thicknesses of concrete structure 10.

Outer frame 140 preferably carries moveable cutting assemblies that, as is discussed in detail below, cut through the concrete wall of concrete structure 10 to create blocks that may then be tipped into the interior of concrete structure 10 and fall safely to the bottom. More particularly, outer frame 140 may carry first and second cutting subframes 150, each having a moveable cutting head with a jet 152 that may be moved in the X-direction (i.e., generally horizontally in a downward (e.g., between 2° and 8° degrees), circumferential cut through the concrete structure 10), and in the Z-direction (i.e., generally vertically in a direction generally parallel to the major axis of the concrete structure 10). Cutting jets 152 are preferably configured to produce a jet of high pressure water, e.g., water at a pressure of 35,000 p.s.i., capable of cutting completely through the width of the concrete wall of structure 10. Each subframe 150 may include an X-axis support 154 and a Z-axis support 156. X-axis support 154 preferably provides a horizontal rail on which a roller 158 may roll to move carrier beam 160 along the X-axis direction, in turn moving the associated cutting head 166 and cutting jet 152 along the X-axis direction. Likewise, Z-axis support 156, which is carried by X-axis support 154, provides a vertical rail 162 on which a roller 164 may roll to move cutting head 166 and cutting jet 152 along the Z-axis direction. Moreover, each cutting head 166 preferably includes a rotation box motor swivel assembly 168 that causes cutting jet 152 to move at an adjustable, downward angle as cutting head 166 moves in the X-axis direction, such that concrete structure 10 is cut in downwardly spiraling segments, as discussed in greater detail below. Each cutting head 166 also includes a shield 170 through which the nozzle shaft of cutting jet 152 extends. Shield 170 comprises a curved, vertical panel positioned to wrap around the upstream side of the nozzle of cutting jet 152, and protects cutting head 166 from backward flying debris as concrete structure 10 is cut.

Each cutting subframe 150 also may carry upper stabilizing wheels 172 and lower stabilizing wheels 174 that serve to position each cutting subframe at an optimal distance away from the outer edge of concrete structure 10 so as to provide sufficient clearance for movement and overall operation of moveable concrete cutting vehicle 100.

Likewise, inner frame 130 may carry vertical shield members 176, which may comprise (by way of non-limiting example) steel plates that align with the travel path of each cutting carriage 166 on the internal side of concrete structure 10. Vertical shield members 176 are impacted by debris generated during the cutting operation and high pressure water generated by cutting jets 152 so as to contain such debris and high pressure water in a controlled space inside of the concrete structure 10. Upper stabilizing wheels 172 and lower stabilizing wheels 174 may again be provided on inner frame 130 that serve to position inner frame 130 and each cutting shield member 176 at an optimal distance away from the inner edge of concrete structure 10 so as to provide sufficient clearance for movement and overall operation of moveable concrete cutting vehicle 100.

In accordance with further aspects of an embodiment, the foregoing moveable concrete cutting vehicle 100 may be used in the following manner to demolish a vertical concrete structure, such as a chimney, silo, stack, and the like. First, and particularly before installation of the moveable concrete cutting vehicle 100 on concrete structure 10, workers may perform a per-demolition inspection in accordance with OSHA requirements. Next, rigging and access systems may be set up, including temporary power supply, as are typically used in concrete structure demolition. Next, a demolition exclusion zone is preferably established at the base of the concrete structure 10. Demolition of miscellaneous structural steel appurtenances, including de-energizing of electrical systems, may then be carried out, followed by demolition of the chimney liner system, including any breeching ducts. Next, a containment system may be installed for water collection and removal at the base of concrete structure 10.

Following such preliminary/preparatory steps, moveable concrete cutting vehicle 100 may be rigged and lifted to the top of concrete structure 10 and installed on the top wall 12 of concrete structure 10 so that first track 110 and second track 120 sit atop wall 12, inner frame 130 is positioned on the interior of concrete structure 10 (with the upper adjustable stabilizing wheels 172 and lower adjustable stabilizing wheels 174 of inner frame 130 in contact with the interior wall of concrete structure 10), and outer frame 140 is positioned on the exterior of concrete structure 10 (with the upper adjustable stabilizing wheels 172 and lower adjustable stabilizing wheels 174 of outer frame 140 in contact with the exterior wall of concrete structure 10). With moveable cutting vehicle 100 positioned on top wall 12 of concrete structure 10, water and hydraulic hoses may be connected to their assemblies on moveable cutting vehicle 100, and one or more water pumps may be positioned at the base of concrete structure 10 to prepare the moveable concrete cutting vehicle 100 for operation.

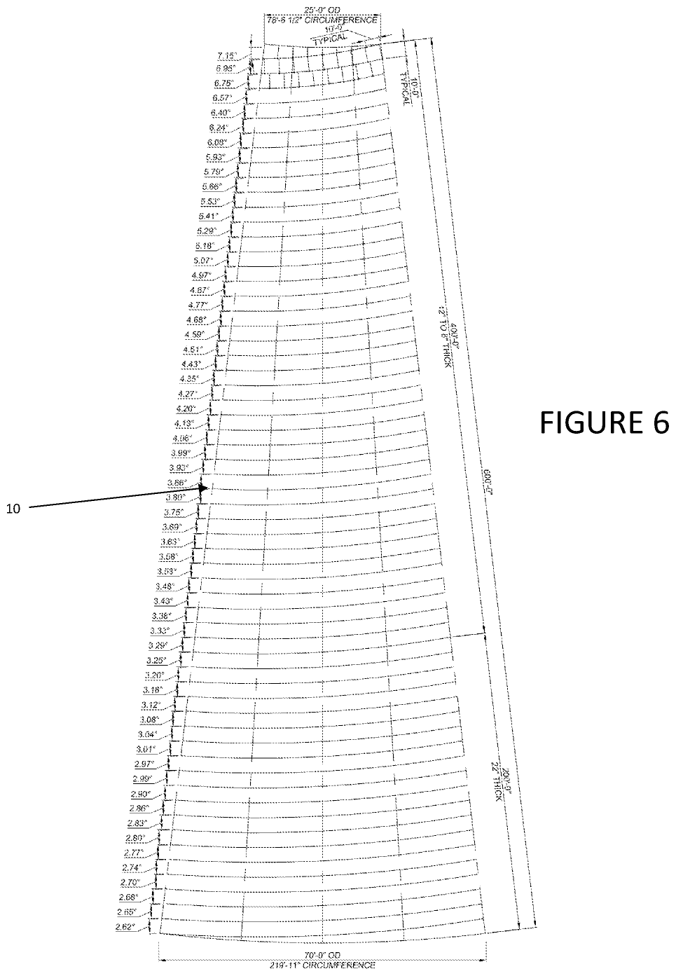

With reference to FIG. 6, and in accordance with certain aspects of a particularly preferred embodiment, moveable concrete cutting vehicle 100 then performs sequential generally vertical and downwardly angled circumferential cuts through the concrete of concrete structure 10, generally in the pattern shown in FIG. 6. Specifically, high pressure water jets out of cutting jets 152 to initially impact the outside wall of concrete structure 10 and cuts through the concrete of the wall until piercing the entire wall thickness. Each cutting carriage 166 is moved as explained above to create the generally vertical and downwardly angled circumferential cuts through the concrete wall. Preferably, after a series of such cuts have been made by moveable concrete cutting vehicle 100 in a first defined length of the circumference of concrete structure 10, a secondary concrete block vertical safety support system may be installed (not shown), providing an additional brace on the outside wall of concrete structure 10 that prevents any of the newly cut concrete blocks from falling toward the exterior of concrete structure 10. With the concrete cuts completed for the first defined length of the circumference of concrete structure 10, first track 110 and second track 120 may engaged to move moveable concrete cutting vehicle along the top wall 12 of concrete structure 10 to the next defined length that is to be cut.

With respect to the first defined length that was just processed by moveable concrete cutting vehicle 100, workers may then (using, by way of non-limiting example, bracket scaffolding or other such support mechanisms as are known to those skilled in the art) cut exposed sections of reinforcing steel by first cutting any horizontal bars in the vertical cuts made by moveable concrete cutting vehicle 100 to form a single, separable concrete block, and then cutting any vertical bars in the horizontal cut made by moveable concrete cutting vehicle to form that single, separable concrete block, starting from the inside curtain of the reinforcing steel. Once all of those cuts have been completed, a worker may then tip the fully separated concrete block into the interior of concrete structure 10, allowing it to fall to the ground. With that block removed, the worker may then clean up the new portion of top wall 12 of concrete structure 10, removing any stub reinforcing steel and any projecting steel reinforcement that might otherwise prevent smooth travel of moveable concrete cutting vehicle 100, and thereafter proceed with engaging moveable concrete cutting vehicle 100 to resume demolition operations on the next defined length of the circumference of concrete structure 10.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A moveable concrete cutting vehicle, comprising:
a moveable and steerable carriage adapted to ride along a top, horizontal wall adjacent an outer edge of a vertical concrete structure during demolition of said vertical concrete structure; and
a cutting assembly carried by said moveable and steerable carriage, wherein said cutting assembly is moveable in at least two directions with respect to said carriage, and wherein said cutting assembly is positioned with respect to said carriage to make horizontal cuts through an outer wall of said concrete structure.

2. The moveable concrete cutting vehicle of claim 1, said moveable and steerable carriage further comprising a plurality of track assemblies pivotably connected to one another.

3. The moveable concrete cutting vehicle of claim 1, wherein one of said at least two directions is vertical, and wherein another of said at least two directions is angularly downward.

4. The moveable concrete cutting vehicle of claim 1, said cutting assembly including a moveable cutting head and a high-pressure water jet.

5. The moveable concrete cutting vehicle of claim 4, wherein said cutting assembly is positioned on an outside of said concrete structure such that water from said water jet extends into an interior of said concrete structure.

6. The moveable concrete cutting vehicle of claim 4, further comprising a shield between an outlet of said water jet and said moveable cutting head.

7. The moveable concrete cutting vehicle of claim 1, wherein said cutting assembly is moveable along a horizontal rail and a vertical rail carried by said carriage.

8. The moveable concrete cutting vehicle of claim 7, wherein said horizontal rail and said vertical rail are each mounted to a frame carried by said carriage.

9. The moveable concrete cutting vehicle of claim 8, wherein said frame is moveable toward and away from said carriage.

10. The moveable concrete cutting vehicle of claim 8, further comprising a stabilizing wheel mounted to said frame and engaging a vertical wall of said concrete structure and configured to position said frame and said cutting assembly at a desired distance from said vertical wall of said concrete structure.

11. The moveable concrete cutting vehicle of claim 1, further comprising an inner shield carried by said carriage.

12. The moveable concrete cutting vehicle of claim 11, wherein said inner shield is aligned with a range of movement of said cutting assembly and positioned with respect to the carriage on an opposite side from said cutting assembly.

13. The moveable concrete cutting vehicle of claim 12, wherein said inner shield is positioned on an opposite side of said outer wall of said concrete structure from the cutting assembly.

14. The moveable concrete cutting vehicle of claim 12, wherein said inner shield is mounted to a frame carried by said carriage.

15. The moveable concrete cutting vehicle of claim 14, wherein said frame is moveable toward and away from said carriage.

16. The moveable concrete cutting vehicle of claim 14, further comprising a stabilizing wheel mounted to said frame and engaging a vertical wall of said concrete structure and configured to position said frame and said inner shield at a desired distance from said vertical wall of said concrete structure.

17. A method for demolishing a concrete structure, comprising the steps of:
providing a moveable concrete cutting vehicle comprising:
a moveable and steerable carriage adapted to ride along a top, horizontal wall adjacent an outer edge of a vertical concrete structure during demolition of said vertical concrete structure; and
a cutting assembly carried by said moveable and steerable carriage, wherein said cutting assembly is moveable in at least two directions with respect to said carriage, and wherein said cutting assembly is positioned with respect to said carriage to make horizontal cuts through an outer wall of said concrete structure;
positioning said moveable concrete cutting vehicle so that said carriage is positioned on a top surface of a wall of said concrete structure and said cutting assembly is positioned on an outside of said concrete structure;
moving said cutting assembly to perform a plurality of vertical and downwardly angled circumferential cuts through said wall of said concrete structure below said carriage;
moving said carriage along said top surface of said concrete structure; and
tipping cut blocks of said wall of said concrete structure into an interior of said concrete structure to create a new top surface of said wall of said concrete structure.

18. The method for demolishing a concrete structure of claim 17, further comprising the step of moving said carriage to said new top surface of said wall of said concrete structure.

19. The method of claim 18, further comprising the step of moving said cutting assembly to perform a plurality of vertical and downwardly angled circumferential cuts through said wall of said concrete structure below said new top surface of said concrete structure.
